(19) United States
(12) Patent Application Publication
(10) Pub. No.: US 2006/0091663 A1
(43) Pub. Date: May 4, 2006

(54) Wheelchair with telescopic anti-tip wheel

(75) Inventors: David P. Jackson, Stafford (GB); Peter W. Gillett, Halesowen (GB); Gavin McKinnell, Telford (GB)

Correspondence Address: MACMILLAN SOBANSKI & TODD, LLC;ONE MARITIME PLAZA FOURTH FLOOR, 720 WATER STREET, TOLEDO, OH, 43604-1619, US

(73) Assignee: Sunrise Medical HHG Inc.

(21) Appl. No.: 11/254,485

(22) Filed: Oct. 20, 2005

Related U.S. Application Data
(60) Provisional application No. 60/620,942, filed on Oct. 21, 2004.
(60) Provisional application No. 60/621,431, filed on Oct. 22, 2004.

(51) Int. Cl. B62D 49/08

(52) U.S. Cl. 280/755

(57) ABSTRACT

A wheelchair has a base and a front anti-tip wheel assembly that retracts when impacted by an obstruction encountered by the wheelchair, but is maintained in an extended position when the wheelchair undergoes forward pitch. Also, the wheelchair has a swingaway light mounting system that includes a mounting receiver and a swinging light bracket mounting one or more lights. The swinging light bracket is mounted for rotation when impacted by an obstruction encountered by the wheelchair.

### RELATED APPLICATIONS

This application claims priority from U.S. Provisional Patent Application Ser. No. 60/620,942, filed Oct. 21, 2004, and entitled WHEELCHAIR REVERSIBLE BETWEEN FRONT WHEEL DRIVE AND REAR WHEEL DRIVE. This application also claims priority from U.S. Provisional Patent Application Ser. No. 60/621,431, filed Oct. 22, 2004, and entitled WHEELCHAIR WITH TELESCOPIC ANTI-TIP WHEEL.

### TECHNICAL FIELD

This invention relates to wheelchairs.

### BACKGROUND OF THE INVENTION

Wheelchairs frequently are designed with a pair of front wheels and a pair of rear wheels. Power wheelchairs are usually one of three varieties, front wheel drive, rear wheel drive, and mid wheel drive. Wheelchairs are often equipped with anti-tip wheel wheels to prevent the wheelchair from tipping over. Some wheelchairs are equipped with running lights and turn signals.

### SUMMARY OF THE INVENTION

According to this invention there is provided a wheelchair having a base and a front anti-tip wheel assembly that retracts when impacted by an obstruction encountered by the wheelchair, but is maintained in an extended position when the wheelchair undergoes forward pitch.

According to this invention there is also provided a wheelchair having a base and a front anti-tip wheel assembly that includes an anti-tip wheel mounted in an extended forward position during normal operation and subject to retraction in a rearward direction along a longitudinal axis when impacted by an obstruction encountered by the wheelchair. The anti-tip wheel is mounted for easy retraction when the anti-tip wheel is impacted by a force along the longitudinal axis, but is maintained in the extended position when the anti-tip wheel is impacted by a force at an angle to the longitudinal axis.

According to this invention there is also provided a wheelchair having a swingaway light mounting system that includes a mounting receiver and a swinging light bracket mounting one or more lights. The swinging light bracket is mounted for rotation when impacted by an obstruction encountered by the wheelchair.

According to this invention there is also provided a wheelchair having a swingaway light mounting system that includes a mounting receiver and a swinging light bracket mounting one or more lights, with the swinging light bracket being mounted for rotation when impacted by an obstruction encountered by the wheelchair. The swinging light bracket is mounted so that it can be rotated in either a forward or rearward direction, and the light mounting system is configured to provide a resistive force urging the swinging light bracket to return to a neutral position when the swinging light bracket is rotated in either the forward or the rearward direction. The mounting system includes a hub mounted within the receiver, with the receiver having a cam profile at an upper end, and the hub having a cam profile at a lower end. The hub is urged into engagement with the mounting receiver by a spring, wherein rotation of the swinging light bracket compresses the spring, thereby urging the swinging light bracket to return to a neutral position.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic view in elevation of a wheelchair in a front wheel drive mode.

FIG. 1A is a schematic view in elevation of the base of the wheelchair.

FIG. 2 is a schematic perspective view of the underside of the wheelchair of FIG. 1.

FIG. 3 is a perspective view of the anti-tip wheel assembly in an extended position.

FIG. 4 is a perspective view of the anti-tip wheel assembly in a retracted position.

FIG. 5 is an exploded view of the anti-tip wheel assembly in perspective.

FIG. 6 is perspective view of a wheelchair light and turn indicator swingaway mounting system.

FIG. 7 is a plan view of the swingaway mounting system with the swingaway light in a neutral position.

FIG. 8 is a plan view of the swingaway mounting system with the swingaway light moved after an impact from the front.

FIG. 9 is a plan view of the swingaway mounting system with the swingaway light moved after an impact from the rear.

FIG. 10 is an exploded schematic view of the swingaway mounting system.

FIG. 11 is a perspective view similar to that of FIG. 6, but from a different angle.

FIG. 12 is a bottom perspective view of the swingaway mounting system.

FIG. 13 is a side elevation view of the swingaway mounting system.

FIG. 14 is a cross-sectional view in elevation of the swingaway mounting system, taken along line 14-14 of FIG. 13.

### DETAILED DESCRIPTION OF THE INVENTION

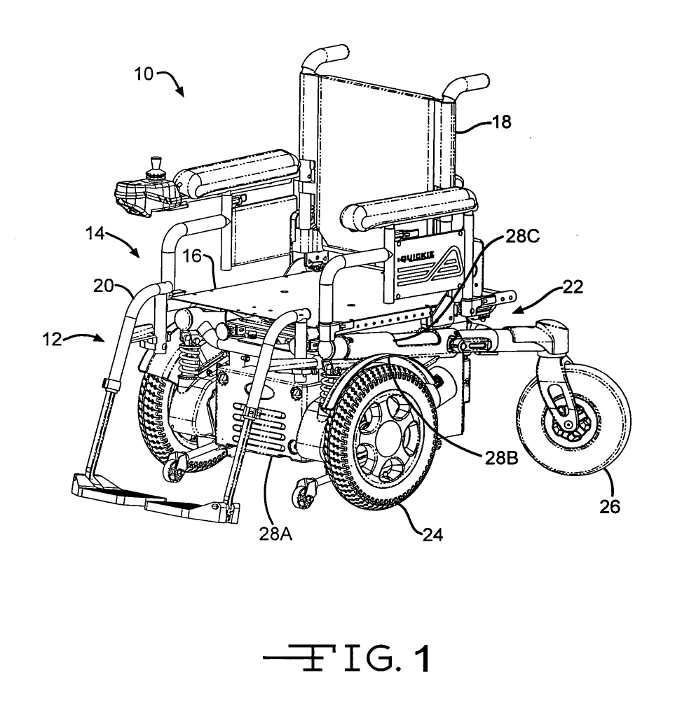

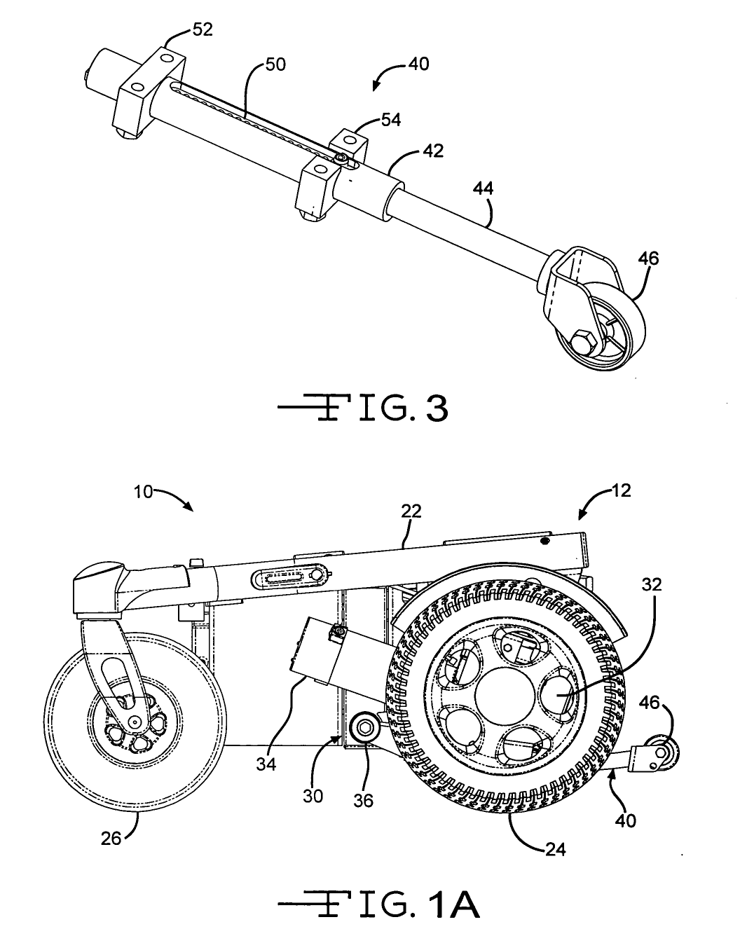

As illustrated in FIGS. 1, 1A and 2, the wheelchair, indicated generally at 10, includes a base 12 and seat assembly 14. The seat assembly includes a seat 16, a seat back 18, and optional leg rests 20. The base 12 includes a chassis 22, drive wheels 24 and caster wheels 26. A drive wheel swing arm, indicated generally at 30, includes a gear box 32 that is fixed to the swing arm 30 by bolting or any other suitable fastening mechanism. Mounted to the gearbox is a drive motor 34. The drive wheel 24 is mounted to the gear box 32. The swing arm 30 enables the drive wheel 24 to move up and down relative to the chassis 22, pivoting at pivot point 36. The wheelchair is optionally provided with removable shrouds, such as front shroud 28A, drive wheel shroud 28B, side rail shrouds 28C,

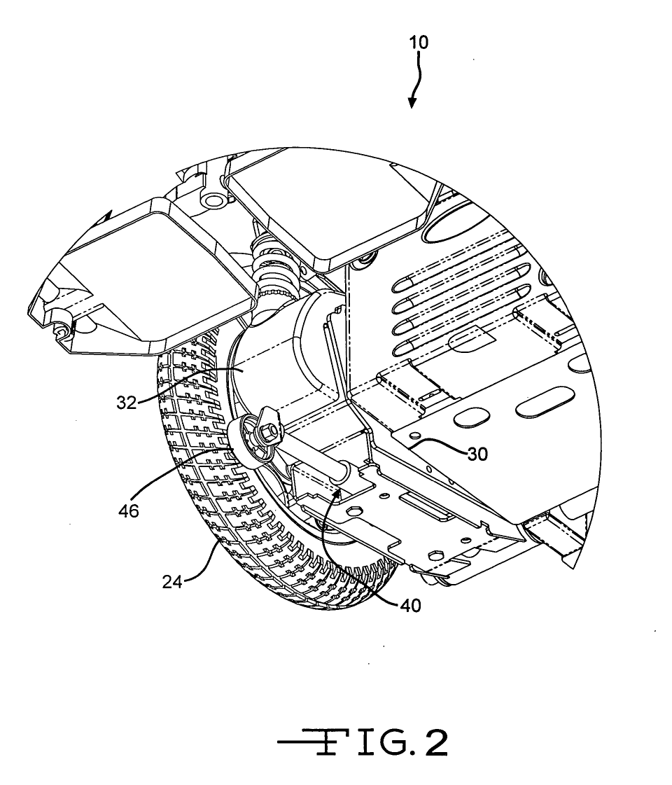

An anti-tip wheel assembly 40 is mounted to the swing arm 30, projecting in a forward direction. As further shown in FIGS. 3-5, the anti-tip wheel assembly 40 includes an outer or rearward tube 42 configured to telescopingly receive an inner or forward tube 44. The anti-tip wheel 46 is mounted at the forward end of the inner tube 44. The outer and inner tubes 42 and 44 can be of any shape or material. Preferably they are made of tubular aluminum members. Although the anti-tip wheel assembly shown has the forward tube 42 being telescopically received within the rearward tube 44, it is to be understood that this can be reversed, with the forward tube receiving the rearward tube.

The outer and inner tubes 42 and 44 can be of a size and shape such that as long as there is no canting, or sideways or vertical component of force applied to the tubes, the inner tube 44 will slide easily within the outer tube 42. If there is a somewhat sideways or vertical component to the force applied to the inner tube 44, however, the inner tube 44 will not slide easily within the outer tube 42. Any force other than a linear or axial force applied to the inner tube 44 in the direction of the longitudinal axis 48 of the anti-tip wheel assembly will produce a sideways or vertical component to the force, and hence will cause the inner tube 44 to slide less easily or not at all within the outer tube 42. The amount of resistance to sliding produced by a sideways or vertical component to the force applied to the inner tube 44 may depend on the relative proportion of the force in the longitudinal direction to the component of sideways or vertical force. The amount of resistance may also depend on the coefficient of friction of the inner surface of the outer tube 42 and the coefficient of friction of the outer surface of the inner tube 44.

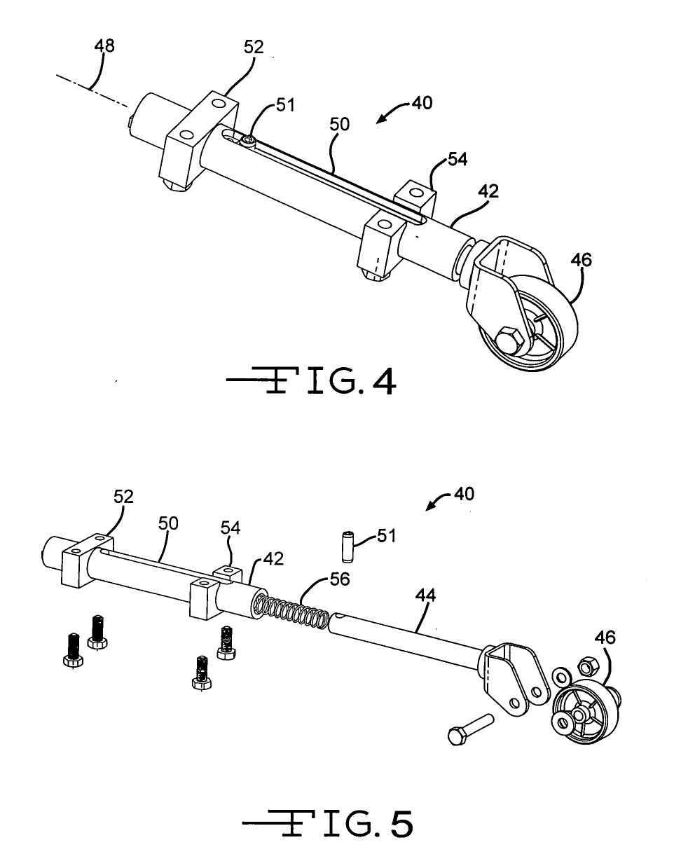

A retaining mechanism, such as a slot 50 and a retaining pin 51, can be used to limit the relative positions of the outer and inner tubes 42 and 44. The pin is shown connected to the inner tube 44, although the pin can be on the outer tube 42. As the inner tube 44 slides within the outer tube 42, the pin 51 can travel the length of the slot 50. Any means suitable for limiting the relative positions of the tubes 42 and 44 to a specified range can be used. The anti-tip wheel assembly 40 can include a rear bracket 52 and a mid bracket 54 to attach the anti-tip wheel assembly 40 to the swing arm 30. More specifically, the outer tube 42 is attached to the swing arm 30. As shown in FIG. 5, a spring 56 is positioned within the inner and outer tubes 42 and 44. The spring 56 is attached to the pin 51 or to the inner tube 44. The rearward end of the spring 56 is attached to the rearward end of the outer tube 42.

In operation, when the rear wheel drive wheelchair 10 encounters an obstacle, such as a curb, the impact of the anti-tip wheel 46 against the curb will cause the inner tube 44 to retract within the outer tube 42, against the force of the spring 56. In the event that the wheelchair 10 is experiencing a condition of forward pitch, the swing arm 30 will pivot relative to the wheelchair chassis 22, and the axis 48 of the anti-tip wheel assembly 40 becomes at an acute angle to the ground. A non-axial force is applied to the inner tube 44, and the inner tube is prevented from sliding rearwardly into the outer tube 42. During normal driving on flat ground, the inner tube 44 is fully extended due to the spring pressure. The anti-tip wheel 46 is positioned forward of the drive wheel 24 so that when the wheelchair stops suddenly and pitched forward, the anti-tip wheel 46 contacts the ground and prevents the wheelchair from tipping over. Accordingly, the anti-tip wheel assembly 40 can effectively act as an anti-tip device, preventing or at least inhibiting the wheelchair from tipping over forwardly.

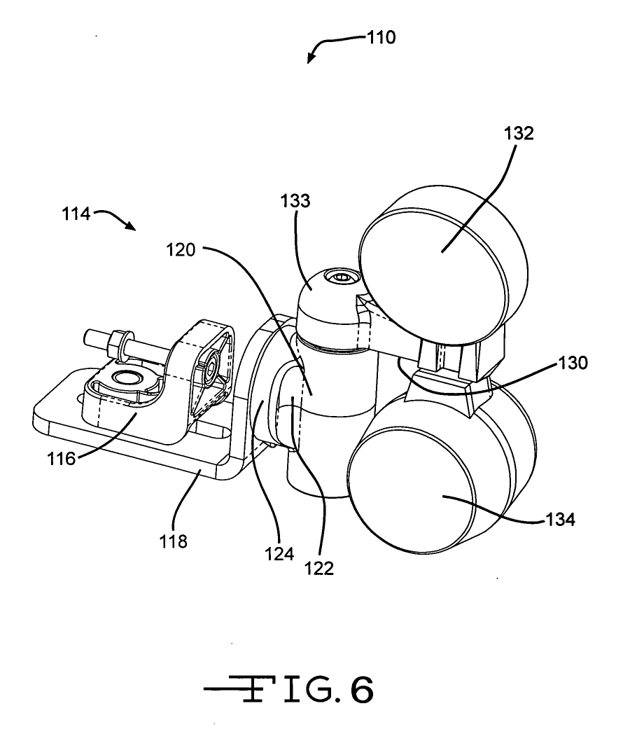

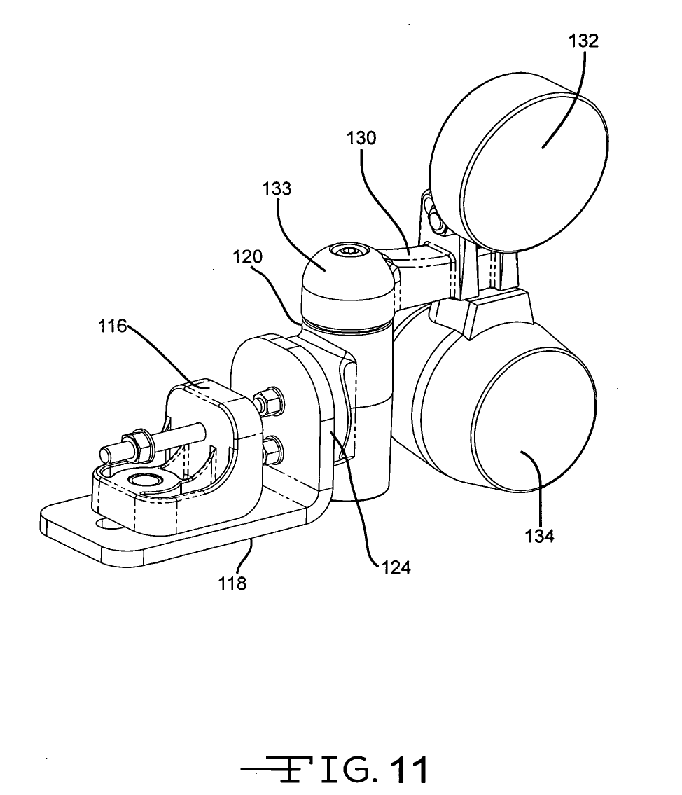

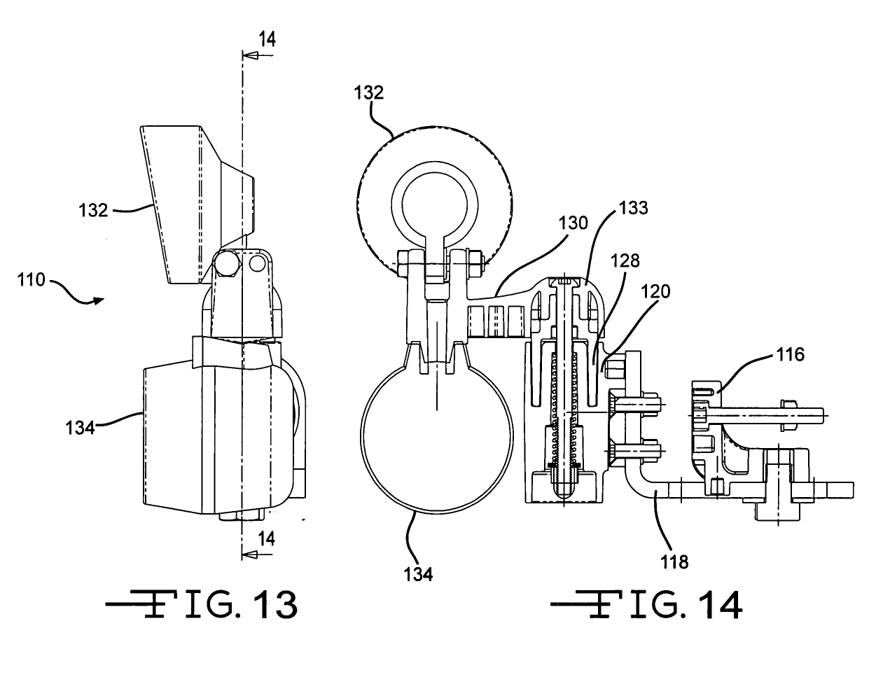

In another aspect of the invention, the wheelchair is provided with a wheelchair light and turn indicator light system attached to the wheelchair 10 with a swingaway mounting system. As shown in FIGS. 6, 11, 13 and 14, the light system 110 includes a swing away bracket assembly 114. A bracket 116 is fixed to the seat frame or any other desirable part of the wheelchair 110. An adjustable bracket 118 is connected to the fixed bracket 116. A mounting receiver 120 has an attachment fixture 122 mating with the fixture 124 on the adjustable bracket 118. A hub 128 is positioned concentrically within the receiver 120. A swinging light r cap 133 is mounted on top of the hub 128 and the receiver 120. The swinging light cap has a swing light bracket 130 for holding the head light 132 and the turn indicator 134. Any type of light can be attached.

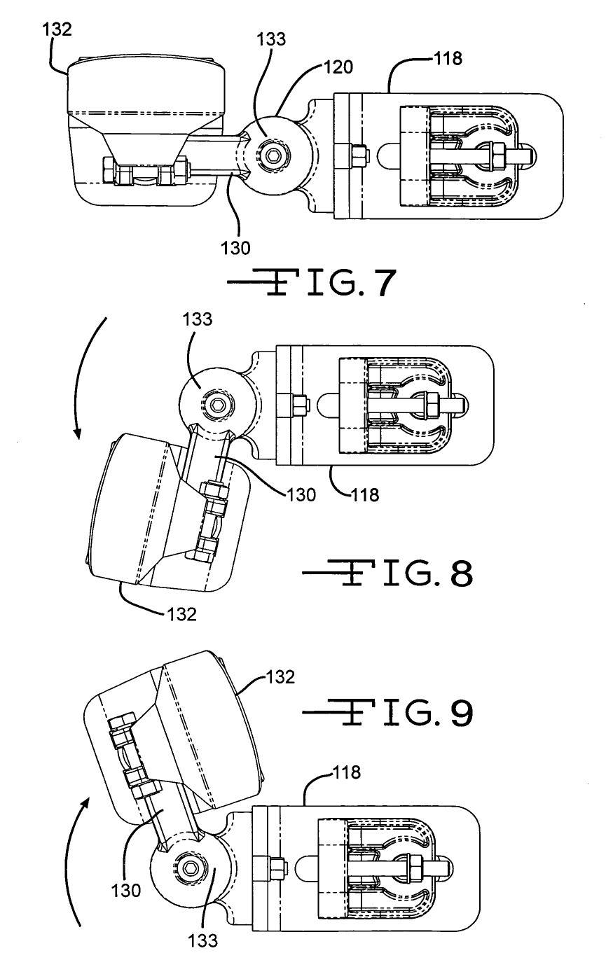

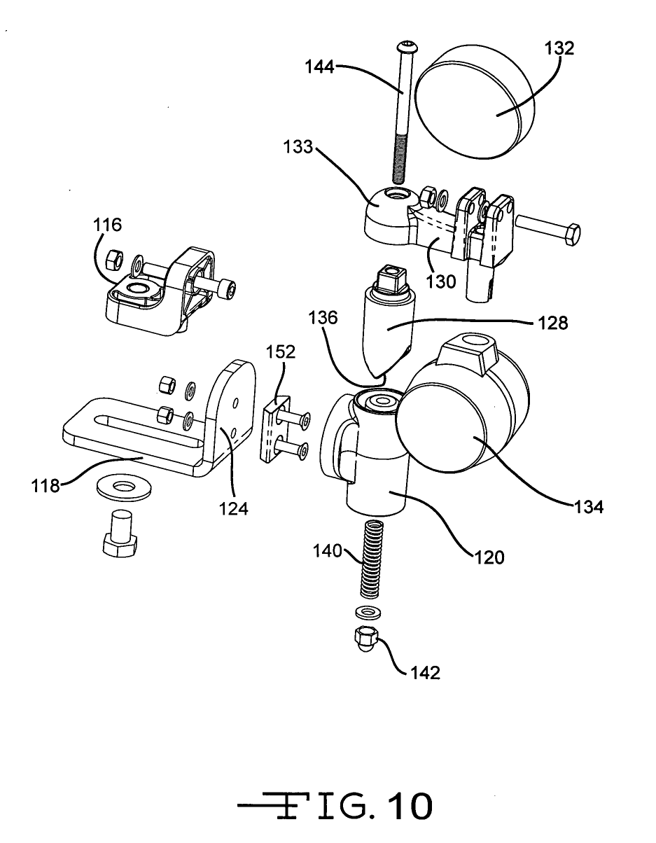

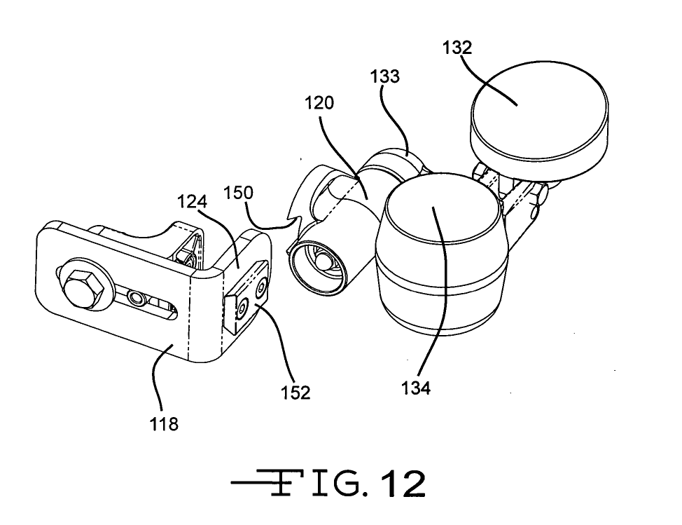

As shown in FIG. 10, the hub 128 has a cam profile 136 at its lower end. The hub 128 is urged into engagement with the mounting receiver 120 by the spring 140, nut 142 and bolt 144. The mounting receiver 120 also has a cam profile. The hub 128 and the receiver 120 are held together as an assembly by the bolt 144 and locking nut 142. The spring 140 is always in some compression. This allows the swing light bracket 130 to maintain a neutral position perpendicular to the adjustable bracket 118, as shown in FIG. 7. If the light assembly receives an impact from the front, as shown in FIG. 8, the swinging light bracket 130 rotates and at the same time the hub 128 rises as it follows the cam profile. This compresses the spring 140 further, providing a resistive force that urges the swinging light bracket 130 back into a neutral position. Once the obstruction is clear, the compression in the spring 140 forces the swinging light bracket 130 to return to the center or neutral position. The reverse happens for an impact from the rear, as shown in FIG. 9. As shown in FIG. 12, the mounting reciver 120 has a dovetail wedge groove 150, and this connects with the dovetail strip 152 on the bracket fixture 124 of the bracket 118. It is to be understood that any attachment system can be used.

The principle and mode of operation of this invention have been described in its preferred embodiments. However, it should be noted that this invention may be practiced otherwise than as specifically illustrated and described without departing from its scope.

What is claimed is:

1. A wheelchair having a base and a front anti-tip wheel assembly that retracts when impacted by an obstruction encountered by the wheelchair, but is maintained in an extended position when the wheelchair undergoes forward pitch.

2. The wheelchair of claim 1 in which the anti-tip wheel assembly includes an outer tube that slidingly receives an inner tube.

3. The wheelchair of claim 2 in which the inner tube is positioned forward of the outer tube, and in which an anti-tip wheel is attached to the inner tube.

4. The wheelchair of claim 2 including retaining mechanism for limiting the travel of the inner tube within the outer tube.

5. The wheelchair of claim 4 in which the retaining mechanism includes a slot and a retaining pin.

6. A wheelchair having a base and a front anti-tip wheel assembly that includes an anti-tip wheel mounted in an extended forward position during normal operation and subject to retraction in a rearward direction along a longitudinal axis when impacted by an obstruction encountered by the wheelchair, wherein the anti-tip wheel is mounted for easy retraction when the anti-tip wheel is impacted by a force along the longitudinal axis, but is maintained in the extended position when the anti-tip wheel is impacted by a force at an angle to the longitudinal axis.

7. The wheelchair of claim 6 in which the anti-tip wheel assembly includes an outer tube that slidingly receives an inner tube.

8. The wheelchair of claim 7 in which the inner tube is positioned forward of the outer tube, and in which an anti-tip wheel is attached to the inner tube.

9. The wheelchair of claim 6 including retaining mechanism for limiting the travel of the inner tube within the outer tube.

10. The wheelchair of claim 9 in which the retaining mechanism includes a slot and a retaining pin.

11. A wheelchair having a swingaway light mounting system comprising a mounting receiver and a swinging light bracket mounting one or more lights, the swinging light bracket being mounted for rotation when impacted by an obstruction encountered by the wheelchair.

12. The wheelchair of claim 11 in which the swinging light bracket is mounted so that it can be rotated in either a forward or rearward direction.

13. The wheelchair of claim 11 in which the light mounting system is configured to provide a resistive force urging the swinging light bracket to return to a neutral position when the swinging light bracket is rotated.

14. The wheelchair of claim 13 in which the swinging light bracket is mounted so that it can be rotated in either a forward or rearward direction, and wherein rotation of the swinging light bracket in either the forward or rearward direction provides a resistive force urging the swinging light bracket to return to a neutral position.

15. The wheelchair of claim 13 in which the mounting system includes a hub mounted within the receiver, the receiver having a cam profile at an upper end, and the swinging light bracket having a cam profile at a lower end, wherein the hub is urged into engagement with the mounting receiver by a spring, and wherein rotation of the swinging light bracket compresses the spring, thereby urging the swinging light bracket to return to a neutral position.

16. The wheelchair of claim 15 in which the swinging light bracket is mounted so that it can be rotated in either a forward or rearward direction, and wherein rotation of the swing light bracket in either the forward or rearward direction provides a resistive force urging the swinging light bracket to return to a neutral position.

17. A wheelchair having a swingaway light mounting system comprising a mounting receiver and a swinging light bracket mounting one or more lights, the swinging light bracket being mounted for rotation when impacted by an obstruction encountered by the wheelchair, with the swinging light bracket being mounted so that it can be rotated in either a forward or rearward direction, with the light mounting system being configured to provide a resistive force urging the swinging light bracket to return to a neutral position when the swinging light bracket is rotated in either the forward or the rearward direction, and where the mounting system includes a hub mounted within the receiver, the receiver having a cam profile at an upper end, and the hub having a cam profile at a lower end, wherein the hub is urged into engagement with the mounting receiver by a spring, and wherein rotation of the swinging light bracket compresses the spring, thereby urging the swinging light bracket to return to a neutral position.
